(19) United States
(12) Patent Application Publication
(10) Pub. No.: US 2006/0182852 A1
(43) Pub. Date: Aug. 17, 2006

(54) Convenient high protein sandwich and method for the production thereof

(76) Inventors: Janusz Wojciak, Calgary (CA); Dinesh Bhatnagar, (US)

Correspondence Address: Janusz Wojciak, 126 Somerglen Close SW, Calgary, AB, T2Y 3Z5, CA

(21) Appl. No.: 11/059,031

(22) Filed: Feb. 17, 2005

(51) Int. Cl. A23L 1/00

(52) U.S. Cl. 426/274

(57) ABSTRACT

The invention provides a sandwich that consist of a substrate of high protein material like cooked muscle meat, meat emulsion or textured plant protein mixed with spices having a an oval, round or square shape of a hamburger, shape of a cylinder or a cylindrical ring. The substrate portion is surrounded by a cover created of carbohydrate materials like bread crumbs, flour and having a shape of the said substrate and a substantially continuous wall forming an integral shell and cavity that embraces and adhering to the aforementioned substrate.

A new method of preparation of a food product designated for a quick, convenient preparation and serving.

References Cited
U.S. Patent Documents

| | | | |
|---|---|---|---|
| 6,599,545 | July, 2003 | Holbrook | 426/94 |
| 6,004,596 | December, 1999 | Kretchman, et al. | 426/94 |
| 5,622,742 | April, 1997 | Carollo | 426/279 |
| 5,780,082 | July, 1998 | Rebeaud | 426/94 |
| 4,888,192 | December, 1989 | Ramnarine | 426/448 |
| 4,765,998 | August, 1988 | Pak, et al. | 426/92 |
| 1,807,189 | May, 1931 | Bemis | 426/92 |
| WO 94/09644 | April, 1998 | International Patent | |

### OTHER REFERENCES

“50 Great Sandwiches”, Carole Handslip, pp. 81-84, 86, 95, 1994.

### U.S. PATENT DOCUMENTS

U.S. Pat. No. 6,397,730 Sandwich and method for the production thereof

U.S. Pat. No. 6,245,368 Pre-assembled sandwich bulk packaging and method of sale

U.S. Pat. No. 6,093,431 Pre-cooked sandwich packaging and method of reheated sale

U.S. Pat. No. 5,955,133 Methods for wrapping sandwich type products

U.S. Pat. No. 5,632,379 Sandwich serving container

U.S. Pat. No. 5,546,848 Sandwich preparation apparatus

U.S. Pat. No. 5,540,943 Sandwich preparation apparatus

U.S. Pat. No. 5,493,958 Sandwich preparation apparatus

U.S. Pat. No. 5,484,613 Device for preparing sandwich meat

U.S. Pat. No. 5,374,438 Quick-setting sandwich biscuit cream fillings

U.S. Pat. No. 5,359,925 Apparatus for producing an edible sandwich

U.S. Pat. No. 5,181,649 Sandwich serving container

U.S. Pat. No. 5,123,689 Sandwich spatula

U.S. Pat. No. 5,113,754 Apparatus for processing sandwich ingredients

U.S. Pat. No. 5,113,753 Apparatus for automatic application of condiments to a sandwich

U.S. Pat. No. 4,879,125 Sandwich in a lunch box

U.S. Pat. No. 4,795,648 Sandwich wrapper and method of wrapping

U.S. Pat. No. 4,703,688 Sandwich-filling apparatus

U.S. Pat. No. 4,670,276 Process for producing sandwich-like foods based on surimi

U.S. Pat. No. 4,653,685 Dual compartment sandwich package

U.S. Pat. No. 4,608,918 Apparatus for manufacturing sealed sandwich style buns

U.S. Pat. No. 4,202,260 Automatic sandwich making apparatus

U.S. Pat. No. 4,179,985 Sandwich cooking and assembling unit

U.S. Pat. No. 4,143,165 Foldable package for meat sandwich

U.S. Pat. No. 4,137,333 Packaged meat sandwich

### BACKGROUND OF THE INVENTION

1. Field of the Invention

The invention provides a sandwich that consist of a substrate of high protein material like cooked muscle meat, meat emulsion or textured plant protein mixed with spices having a an oval, round or square shape of a hamburger, shape of a cylinder or a cylindrical ring. The substrate portion is surrounded by a cover created of carbohydrate materials like bread crumbs, flour and having a shape of the said substrate and a substantially continuous wall forming an integral shell and cavity that embraces and adhering to the aforementioned substrate.

2. Description of the Prior Art

Different fast food restaurants and retail grocery stores offer wide range of food products that are designed to satisfy basic nutritional needs of people that do not have time to prepare their own breakfast, lunch or dinner. The segment of the industry called fast food industry is supplying such ready meals or sandwiches in multiple public outlets. Typically a sandwich created in such outlets comprises of a bun, bread or other edible, manually prepared wrapping that is separated by knife with an aid of devices like bun or bagel cutters, then a flat meat portion, like grilled beef, pork or chicken patty is inserted between top and bottom part of a bun, bread etc. The meat portion is either a muscle part or it is ground and formed meat. Additionally, toppings are put on top of the meat portion. Slices of tomato, onion rings, lettuce, slice of cheese, bacon are placed at the bottom and/or on top of meat portion and covered with mayonnaise, sauces, salt and spices. Placing both parts of a bun finishes the complete sandwich. Other commercially available and homemade of sandwiches are created cutting horizontally bagels and spreading butter, cream cheese etc. Bagels are commonly hard rolls, which are shaped like a donut i.e. circular with a hole in the center. They are made of raised dough in a process, which includes simmering in boiling water, which is followed by baking. The plain bagel has a glazed browned hard exterior over a firm white interior.

The disadvantage of this type of popular sandwich is that its preparation requires considerable time and excessive manual labor. The components of such sandwiches need to be purchased from multiple sources and are manufactured by various food processing companies using considerable amount of energy, labor and transferring considerable cost throughout the distribution channels. These factors increase the total cost of final product i.e. sandwiches as all the components must be purchased form different sources, transported stored and assembled into the final product on site at the restaurant counter. Known are hamburger food products comprising two slices of bread having inserted a meat product and a container, the container disposed on the top surface of the hamburger meat adapted to house a salad and structured to contain a concave configuration disposed at the bottom surface having circular edge portion for causing the container to tightly adhere to the meat product, described in the U.S. Pat. No. 4,765,998. Another example of a novel sandwich product is disclosed in the U.S. Pat. No. 1,807,189 where a food product such as a sandwich wherein a bun is split at its sides and bottom end to form a pocket and garnished filler made of edibles is inserted into the pocket. The fillers often consist of a garnish in the form of lettuce, a meat product or hot-dogs, and further garnish or appetizer in the form of pickle slices. However, since the garnish is assembled together with the hot meat product recently cooked, the fresh lettuce and cold pickle in the pocket of this patent is converted to a warm salad. Furthermore, it is still difficult to insert fillers in all quantities into pockets described in this patent. Another example of an attempt to create a convenient sandwich is in the U.S. Pat. No. 6,599,545 wherein a method is described for inserting one foodstuff, such as sandwich fixings, into a section foodstuff, such as a bread bun, which include which includes forming a cavity in the second foodstuff. The disadvantage of this type of sandwich is that its preparation requires complex mechanical device and the final look of the sandwich is not similar to a traditional sandwich.

The international patent application WO 94/09644 describes a sandwich and a method for producing it in which two bread slices and a sandwich filling layer are connected by means of an edible glue. In addition, this arrangement can be compressed using roller elements so that the filling layer is pressed into the bread slices. Although this results in a sandwich, which holds together securely, the production process is complicated because of the application of glue. Moreover, as before some of the filling layer can reach the outside and can possibly soften the outside of the sandwich or make a plate or a serviette necessary for its consumption.

Some efforts have been directed towards improving sandwiches, such as by sealing the contents of the sandwich in the bread, and providing baked shells, examples of which may be found in U.S. Pat. No. 6,004,596. It is believed that the baked shells lack popularity due to the large amount of crust, both on the outside and inside, that is produced. In addition, it is believed that sealing sandwich contents in the bread is only feasible for particular types of sandwich fixings, which prevent moisture from reaching the bread, such as peanut butter. Despite these efforts, the vast majority of sandwiches are produced, both at home and commercially, with the traditional contents “sandwiched” between two slices of bread.

Other food items have been developed, which are similar in many respects to sandwiches, and which may have been developed to address the drawbacks of typical sandwiches. For example, pocket-type food items have a layer of dough wrapped about a meat substance and backed or cooked. Some examples are shown in U.S. Pat. Nos. 5,622,742; 5,780,082; and 4,888,192. It is believed that such types of food are limited to baked or cooked food, and are ill suited for many sandwiches, such as cold cuts. In addition, it is believed that such pocket-type food items are unsuitable for typical sandwiches because the outer, dough layer has a crust consistency, and lacks a bread-like consistency.

In these respects, the convenient sandwich according to the present invention substantially departs from the conventional concepts and designs of the prior art, and in so doing provides a sandwich that can be prepared quickly and easy, saving time and cutting manufacturing, distribution and preparation cost.

### OBJECTS AND SUMMARY OF THE INVENTION

It has been recognized that it would be advantageous to develop a sandwich with traditional texture and consistency, but without traditional messiness, high cost of components, excessive labor involved in preparation and serving. In addition, it has been recognized that it would be advantageous to develop a method for making such sandwich. In addition, it has been recognized to develop a healthy, high protein formula for the sandwich substrate and a method of easy, convenient and quick preparation of such sandwich in the fast-food restaurants and at home.

The invention provides a sandwich that consist of a substrate of high protein material like cooked muscle meat, meat emulsion or textured plant protein mixed with spices having a an oval, round or square shape of a hamburger, shape of a cylinder or a cylindrical ring. The substrate portion is surrounded by a cover created of carbohydrate materials like bread crumbs, flour and having a shape of the said substrate and a substantially continuous wall forming an integral shell and cavity that embraces and adhering to the aforementioned substrate.

In accordance with one aspect of the present invention, the sandwich is a fully cooked foodstuff that is frozen and stored in a freezer and defrosted in a microwave before final preparation. After a short time high-energy uniform microwave defrosting to a room temperature, the sandwich is cut across horizontally with a knife or is cut after being placed in a bagel cutter device and the symmetrical top and bottom portions are separated.

In accordance with another aspect of the invention, both top and bottom parts of the sandwich are symmetrical and maintain the same conformation and consistence after separation. Both parts consist of outer crust that visually and in texture imitate a bun or bread and a substrate adhering to the crust. Final preparation of the sandwich before serving is accomplished by placing the condiments, depending on the preference, like slices of tomato, onion, red or green pepper, slices of cheese or bacon etc. on top of the bottom part of the sandwich. In addition, the condiments are covered with mayonnaise, sauces, spices etc. and the top part of the sandwich is placed on top of the condiments and manually adjusted in order to close the sandwich.

I accordance with another aspect of the present invention, the finished and ready to serve sandwich consist of 1) bottom part of crust and substrate 2) layers of condiments, sauces and spices 3) top part of crust and substrate.

Additional features and advantages of the invention will be set forth in the detailed description which follows, taken in conjunction with the accompanying drawings, which together illustrate by way of example, the features of the invention.

### BRIEF DESCRIPTION OF THE DRAWINGS

FIG. 1 is a schematic view of manufacturing steps illustrating the production method of convenient sandwich.

FIG. 2 is a schematic view illustrating the method of final preparation of a convenient sandwich.

FIG. 3 is a schematic view illustrating the method of final preparation of a convenient bagel sandwich.

### DESCRIPTION OF THE PREFFERED EMBODIMENTS

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

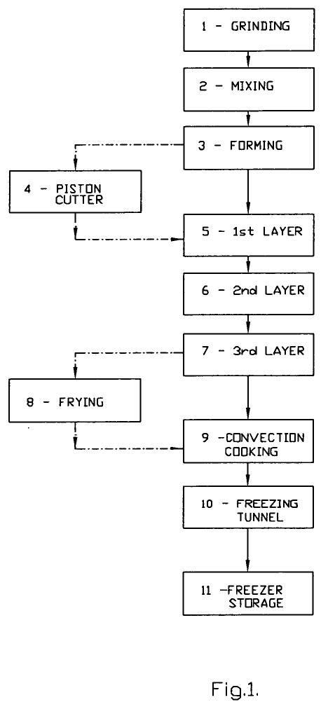

A method of production illustrated in the FIG. 1. The first manufacturing step is the preparation of the substrate. Meat component is cut in a cutter or grinder (1) into smaller pieces and mixed in the mixer (2) with salt, spices, and marinades. Other ingredients that may be used are bacon chips, cheese etc. The preferred cutting size and shape of the meat pieces may vary between 2 mm and 25 mm, depending on the target texture of the cooked substrate and quality of the raw materials used. The species origin of meat may be poultry, pork, beef and mutton. In another embodiment, the substrate part is created from non-meat ingredients like ground vegetables, soy protein, spices and various edible additives. In order to create portions of various preferred shapes, the substrate material must obtain rheological features of a visco-plastic body allowing easy forming. The temperature of the substrate mix must be maintained between 29° F. and 60° F. to allow good forming. The uniformly mixed substrate part is formed under pressure of 100 to 150 psi in a press or forming machine (3) into an oval, round or square shape of a hamburger, shape of a cylinder or a cylindrical ring. In one embodiment, the substrate has a diameter of up 5 inches and thickness of up to 2 inches and weigh up to 5 oz. (141.8 grams). In another embodiment, the formed substrate has a cylindrical hole of 1 inch diameter is created by a circular knife or pressure piston cutter (4). The substrate weight for this conformation is 4.3 Oz. (123 grams). Such formed substrate is passed on a conveyor through the machine system that allows covering the substrate with a crust imitating bun or bread. An exemplary formula of a preferred embodiment is presented in table 1. In one embodiment, the first machine (5) disperse fine flour commercially named pre-dust that covers the whole surface of the substrate portion. The second machine (6) applies a batter that is composed of mixture of water, flour, spices and other binding additives to the dusted surface of substrate portions. The third machine (7) disperses breadcrumbs or sourdough breader crumbs over the battered substrate's surface.

The set of one or more machines used commercially to create a breaded shell around a product e.g. set of Stein® machines represent flow-through system that can be applied to develop a sandwich according to the present invention. Number of coating layers needed to achieve appropriate visual and composition of each layer and number of passing through the machines determines palatable texture. The proportion of weight of the breading cover to the weight of an uncooked sandwich is commercially called a breading pick-up. In this invention the breading pick-up is critical to develop appropriate visual effect and to create attractive shell around the substrate that will imitate bread or bun in the finished sandwich. In one embodiment, the most preferred overall pick-up for all three components of the shell is between 47.4% for a cylindrical substrate weighing 5 oz the pick-up for layers of pre-dust, batter and bread crumbs is 3%, 21.2% and 11.1%, respectively. In the next processing phase, product is cooked in two step or one step cooking cycle. In the first machine (8) product is blenched in oil heated to temperature between 360° F. and 390° F. for a short time between 15 to 40 seconds. Finally, product is cooked in the convection oven (9) for 8 to 14 minutes at temperatures between 450° F. to 500° F. In another embodiment, the cooking process is limited to heating the product in the convection oven (9) for 8 to 15 minutes until it reaches internal temperature of 165 F. Cooked product is individually frozen in the freezing tunnel (10) where the cooling medium is liquid nitrogen released at temperature −170° F. The cooked product temperature is between 0° F. to 5° F. after passing it through the freezing tunnel.

The frozen product is stored in the freezer (11) at −20° F.

TABLE 1
Exemplary formula of the convenient sandwich

| Sandwich | Formula | | |
|---|---|---|---|
| components | component | Proportions | Procedures |
| Substrate | Chicken meat, | 75.25% | Chicken breast ground in |
| | pork or beef | | the grinder into 0.5″ |
| | Seasoning | 2.75% | pieces. Meat mixed with |
| | Soy protein | 4.00% | water and other components |
| | isolate | | for 3 minutes. |
| | Water | 18.00% | |
| Layer 1 | flour | 100.00% | Pre-dust |
| Layer 2 | Water | 88.00% | Isolated Soy Protein mixed |
| | Isolated Soy | 12.00% | thoroughly with water. |
| | Protein | | Batter is created. |
| Layer 3 | Bleached wheat | 20.00% | Covering the dusted and |
| | flour | | battered substrate with |
| | Cultured wheat | 60.00% | the bread crusts creates |
| | flour | | outer shell. |
| | Sugar | 1.00% | |
| | Salt | 1.00% | |
| | Malic acid | 0.50% | |
| | Soy been oil | 1.00% | |
| | Yeast extract | 0.50% | |
| | Yeast | 3.00% | |
| | | 2.00% | |

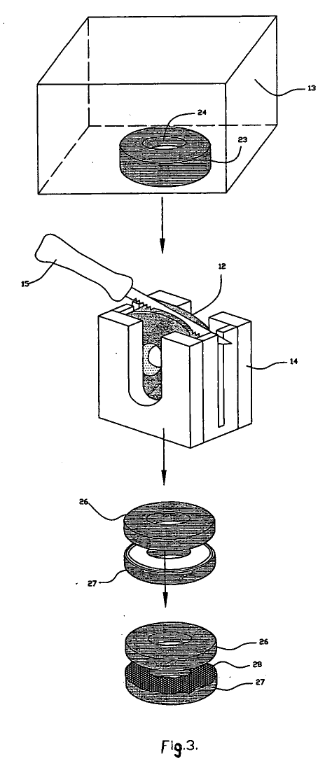

The frozen sandwich weighs between 6.7 Oz and 7.4 Oz. (190-210 grams). The frozen bagel sandwich illustrated on FIG. 3. Weighs between 5.6 Oz and 6.7 Oz. (160-190 grams).

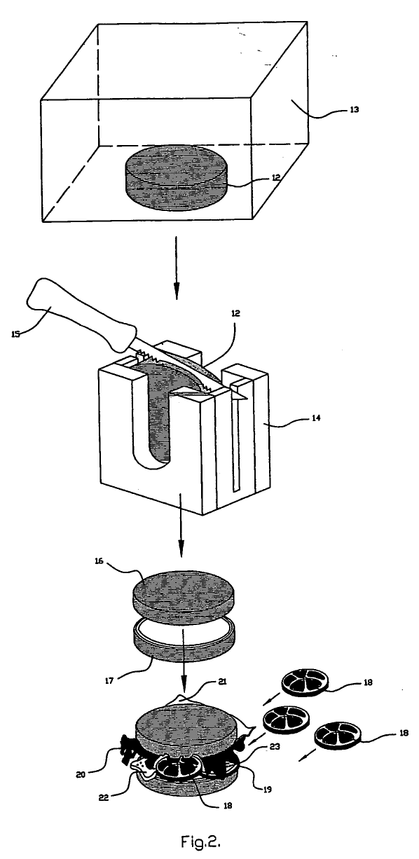

A method of preparation of a convenient sandwich is illustrated in the FIG. 2. Frozen sandwich is placed in the microwave oven and heated for 2 to 3 minutes until the substrate temperature reaches 60° F. to 70° F. (15.5 to 21.1 C). Subsequently, the sandwich (12) is placed in a bagel cutter (13) and cut with a knife (14) and a top portion (15) is separated from bottom portion (15). In order to finalize the sandwich arrangements, the condiments like slices of tomato (16), onion rings (17), lettuce (18), slice of cheese (19), bacon (20) are placed on the bottom of sandwich portion and covered with mayonnaise (21), sauces (22), salt (23) and spices (24). The top part of sandwich is put on top of the condiments and the sandwich is served to the consumer. In another embodiment, the frozen bagel sandwich is placed in the microwave oven and heated for 2 to 3 minutes until the substrate temperature reaches 60 to 70 F (15.5 to 21.1 C). Subsequently, the sandwich (25) is placed in a bagel cutter (12) and cut with a knife (13) and a top portion (26) is separated from bottom portion (27). In order to finalize the sandwich arrangements, butter (28) or cream cheese (28) is spread over the cut surface of the bagel sandwich. The top part of the bagel sandwich is put on the spread and the bagel sandwich is served to the consumer.

The sandwich preparation time is ca. 1 minute, which is a major advantage in fast-food restaurants allowing considerable labor and time saving. Since the sandwich may be kept frozen for extended period of time or may be refrozen again after defrosting, this type of sandwich is a convenient way of serving in the food service industry, restaurants, hotels, hospitals as well as at home. Short time of defrosting the sandwiches in the microwave oven before the cutting and inserting condiments, can be used for preparation of another batch of sandwiches.

What we claim, is

1. A convenient high protein sandwich, comprising:
a) a substrate of high protein material like lean meat emulsion or textured plant protein mixed with spices having a an oval, round or square shape of a hamburger, nugget, finger, cylinder or ring having a diameter of up 5 inches and thickness of up to 2 inches
b) a cover created of carbohydrate materials like bread crumbs, flour or ground flax seed and having a shape of the said substrate and a substantially continuous wall forming an integral shell and cavity that embraces and adhering to the aforementioned substrate

2. Sandwich in accordance with claim 1, wherein:
a) the substrate is created by grinding and mixing food protein materials with spices and/or water until a cohesive emulsion is formed and shaped into a preferentially circular, oval or cylindrical substrate weighing up to 6 oz.
b) the substrate contains between 70% and 76% of lean chicken breast, beef or pork meat, between 17% and 20% of water, minimum 3.5% of isolated soy protein and at least 2% of seasonings
c) a substrate of high protein material, where in the protein content is at least 18% and fat content is not higher then 7%
d) on the substrate a shell is created by covering the substrate with a first layer of flour then a second layer of mixture of flour or soy protein concentrate and water and the third layer of dry flour and/or bread crumbs, ground flax seed, wherein the cover is stabilized and crust consistency is created by heat treatment in a deep fat fryer for 10 to 30 seconds at a temperature from 360° F. to 390° F. and/or baked in convection oven for 8 to 14 minutes at temperatures between 450° F. to 500° F., until the temperature in the center of the substrate is 165° F. and the product is individually quickly frozen.
e) a formed frozen substrate and shell creating together a sandwich weighing from 1.5 oz. to 6 oz. is reheated before serving in the microwave oven for 1 to 2.5 minutes, cut horizontally with a knife, filled up manually with toppings like onion, tomato, lettuce and/or condiments like mayonnaise, sour cream or other commonly used condiments.

3. A frozen food product in accordance with claim 1 suitable for reconstituting in microwave energy wherein a food substrate is about 50% to about 70% and a coat is about 30% to 50% of the total product weight.

4. A frozen food product of claim 1 wherein a food substrate comprises about 70% to 78% ground chicken and about 15% to 20% water and about 2% to 3% seasoning and about 3 to 8% soy protein isolate and said first, second and third coating layers comprise respectively: 2% to 5%, 20% to 25% 10% to 30% of the total food product.

5. A frozen food product of claim 1 wherein a food substrate comprises about 70% to 78% ground pork meat and about 15% to 20% water and about 2% to 3% seasoning and about 3 to 8% soy protein isolate and said first, second and third coating layers comprise respectively: 2% to 5%, 20% to 25% 10% to 30% of the total food product.

6. A frozen food product of claim 1 wherein a food substrate comprises about 70% to 78% ground beef and about 15% to 20% water and about 2% to 3% seasoning and about 3 to 8% soy protein isolate and said first, second and third coating layers comprise respectively: 2% to 5%, 20% to 25% 10% to 30% of the total food product.
